(19) United States
(12) Patent Application Publication
(10) Pub. No.: US 2005/0012734 A1
(43) Pub. Date: Jan. 20, 2005

(54) Method for driving a liquid crystal display device in normal and standby mode

(76) Inventors: Mark Thomas Johnson, Eindhoven (NL); Alwin Rogier Martijn Verschueren, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/497,887

(22) PCT Filed: Nov. 25, 2002
(86) PCT No.: PCT/IB02/04992

(30) Foreign Application Priority Data
Dec. 5, 2001 (EP) 01204683.5

(51) Int. Cl. G09G 5/00

(52) U.S. Cl. 345/211

(57) ABSTRACT

A method for driving a liquid crystal display device according to which the liquid crystal pixel voltage has constant polarity when the display device is operated in standby mode, and alternating polarity when the display device is operated in active mode. As a result it is possible to adjust the gate voltage pulse train to have a lower amplitude when the display device is operated in standby mode. The drive method offers a way to combine the requirements of reduced image retention and lower power consumption.

The present invention relates to a method for driving a liquid crystal display device having pixels comprising liquid crystal material arranged between electrodes, wherein a pixel voltage is provided between said electrodes.

A known phenomenon in LCDs (liquid crystal displays) is the displacement of ions in the liquid, which causes degradation, manifesting itself as image retention. It is a well known fact that an LCD that displays a fixed pattern during a long period of time, e.g. a display that spends long periods in standby mode (such as a phone display), will suffer from image retention, i.e. the standby image will appear as a ghost image when the display is switched into active mode, and a new screen is displayed.

In the past, a solution to this problem has been to drive the LC element with alternating voltage across the electrodes, in order to avoid static displacement of the ions. In other words, each electrode has been provided with alternately positive and negative voltage. Unfortunately, alternating polarity pixel voltage consumes more power.

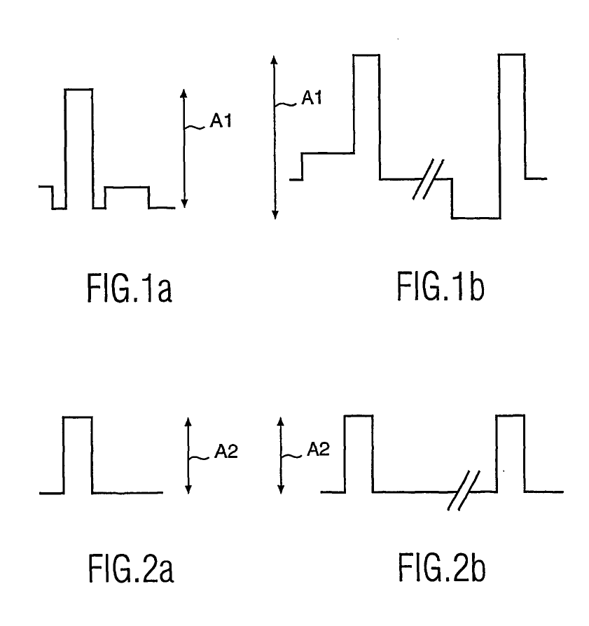

In an AMLCD (active matrix LCD) each pixel is activated or deactivated by a transistor element, such as a TFT (thin film transistor). The transistor element is controlled by a gate voltage pulse train. In order to ensure proper function of the transistor element when the electrode pixel voltage polarity alternates, the amplitude A1 of the gate voltage needs to be high, normally around 25 V (common electrode inversion, FIG. 1a) or even greater than 30 V (4 level inversion, FIG. 1b). This type of gate voltage results in even higher power consumption.

An attempt to reduce power consumption, while maintaining low image retention, is presented in WO 00/41465, by Mark T. Johnson, one of the co-inventors of the present application. In the mentioned document, a liquid crystal display device is described with a specific relationship between the dielectric constants and the resistivities of the liquid crystal material and the layers of orienting material, respectively. The disclosed display device shows little or no image retention when driven by voltage with constant polarity.

When the pixel voltage has constant polarity, the gate voltage can be reduced by the threshold voltage of the liquid crystal material (typically 2V) plus the saturation voltage of the liquid crystal material (typically 6 V). In both cases mentioned above, the gate voltage amplitude A2 could be reduced to around 17 V (see FIGS. 2a and 2b).

It is an object of the present invention to provide an improved method for driving a liquid crystal display device.

This and other objects have been achieved with a method of the kind mentioned by way of introduction, comprising controlling the electrodes to provide a pixel voltage with constant polarity when the display device is operated in standby mode, and controlling the electrodes to provide a pixel voltage with alternating polarity when the display device is operated in active mode.

The pixel voltage is normally defined as the potential difference between a pixel electrode drive voltage on one side of the liquid crystal material, and a common electrode voltage on the other side of the liquid crystal material.

By changing the pixel voltage drive scheme depending on the operation mode of the display, it is possible to combine the advantages of each drive scheme. In active mode, i.e. when the contents of the video signal is rapidly changing, it is advantageous to provide the liquid crystal material with alternating voltage (AC drive). When in standby mode, i.e. when the contents of the video signal is essentially constant, power can be saved by adopting a drive scheme with constant polarity (DC drive). Note that “constant” polarity not necessarily means that the polarity never changes, only that the polarity is constant over several frames in sequence.

It has been found that DC driving can also reduce the image retention build up in an LCD, possibly due to different electrical resistance of the LC layer in DC drive. When the display is activated, the switch to AC drive causes any image retention to be masked, especially if line inversion is implemented.

Power consumption will also be reduced, as the voltage swing over the LC panel (the liquid crystal material and substrates enclosing it) is reduced in DC drive.

The mode of operation can be selected by the user, for example by use of a manual switch adapted for this purpose. However, the method can preferably include the step of detecting whether the display device is in standby or active mode. This detection can then select the correct drive scheme.

A simple way to detect the operation mode is to assume active mode when the apparatus to which the display is connected is in use. Another way to determine the mode of operation is to detect the power level of a power source of the display device. A low level should place the display device in standby mode, in order to prolong the life of the power source. Yet another way to determine the mode of operation is to analyze a video signal supplied to the display device. When such a signal comprises rapidly changing contents, this is indicative of a changing display, and hence an active mode may be appropriate. When such a signal on the other hand is changing slowly, or not at all, this is indicative of a constant display, and a standby mode may be appropriate.

The drive method can also comprise providing a gate voltage to transistor elements in the display device, for activating or deactivating a particular pixel, said gate voltage having the form of a pulse train, and adjusting said pulse train to have a first maximum amplitude when the display device is operated in active mode, and a second maximum amplitude when the display device is operated in standby mode.

In other words, the gate voltage amplitude is adjusted to the liquid crystal drive scheme, where alternating pixel voltage polarity is combined with a first gate voltage amplitude, while constant pixel voltage amplitude is combined with a second gate voltage amplitude.

Preferably, the first amplitude (active mode) is greater than the second amplitude (standby mode). This means that the gate voltage pulse train consumes less power in standby mode, which reduces total power consumption.

It may be preferred to occasionally switch the polarity of the pixel voltage with constant polarity. This can be suitable for example if the display is in standby for a long period of time. As noted above, a pixel voltage with an occasional polarity switch, say every hour or every minute, is still referred to as a constant pixel voltage, as the polarity is constant for several consecutive frames.

Further, the gate voltage pulse train can have a constant pulse amplitude in standby mode, as the pixel voltage does not change polarity with every frame. If and when the constant polarity of the pixel voltage does change, as mentioned above, an offset of the gate voltage pulse train can be adjusted.

These and other aspects of the invention will be apparent from the preferred embodiments more clearly described with reference to the appended drawings.

FIGS. 1a and 1b are diagrams of gate voltage pulse trains adapted to liquid crystal pixel voltages with alternating polarity.

FIGS. 2a and 2b are diagrams of gate voltage pulse trains adapted to liquid crystal pixel voltages with constant polarity.

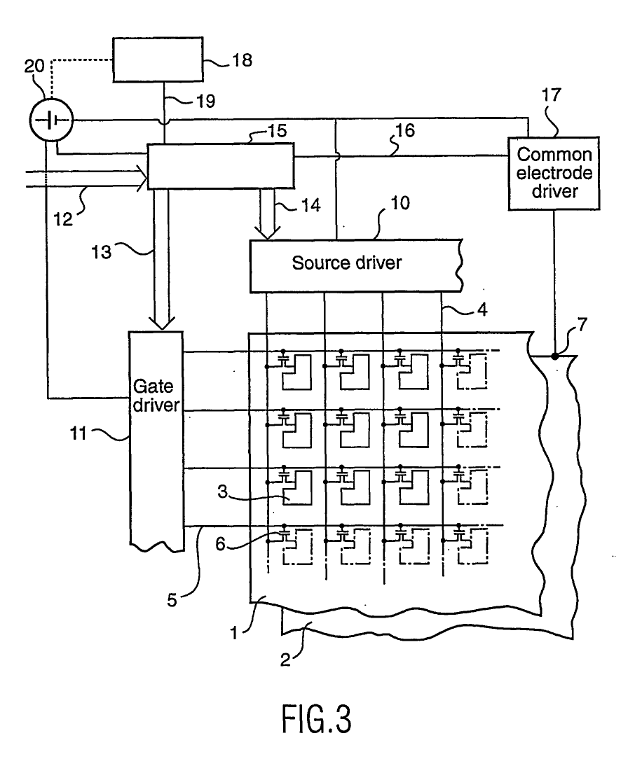

FIG. 3 is a schematic drawing of a section of an active matrix liquid crystal display (AMLCD).

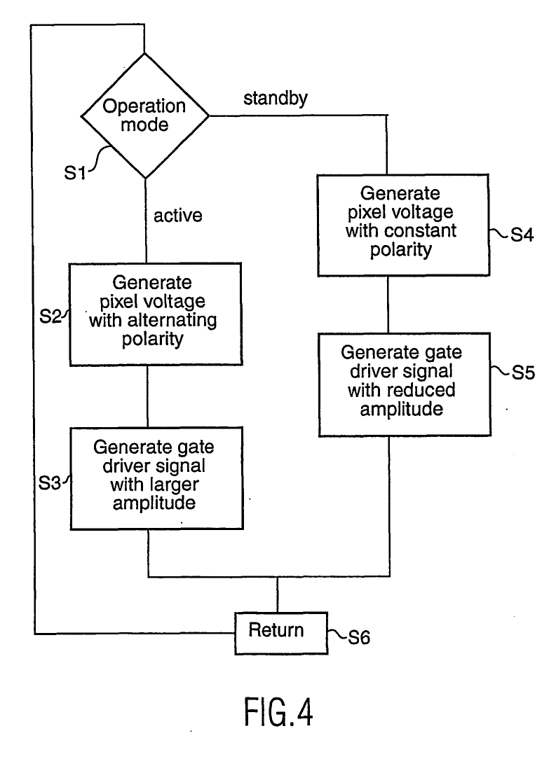

FIG. 4 is a block diagram of the drive method according to an embodiment of the invention.

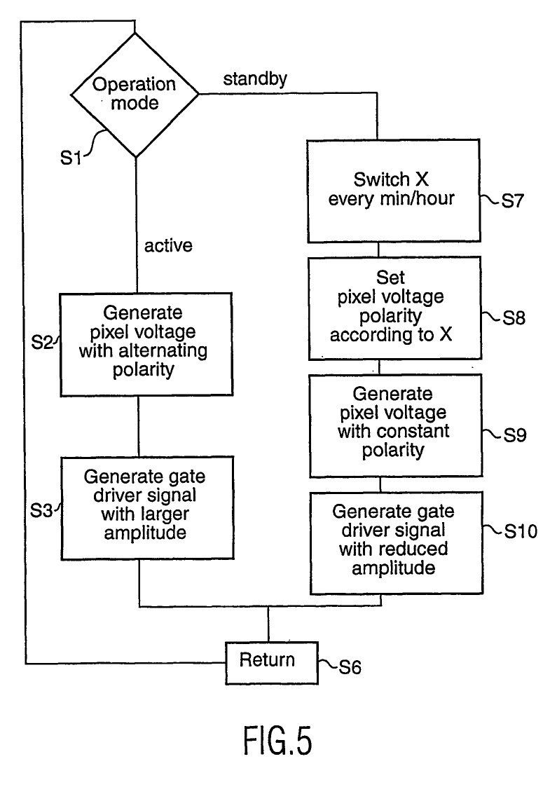

FIG. 5 is a diagram of a gate voltage pulse train.

With reference to FIG. 3, an active matrix liquid crystal display device includes a liquid crystal material arranged between two substrates 1, 2 facing each other. Pixel electrodes 3 are arranged in a matrix on the liquid crystal side of the substrate 1, and signal lines (data lines or source lines) 4 and scanning lines (gate lines) 5 are provided at the periphery of each pixel electrode 3 so as to cross each other. A thin film transistor (TFT) 6 is provided as a switching element in the vicinity of each crossing point of the signal lines 4 and the scanning lines 5. The TFT is connected to the signal line 4 for driving the pixel electrode 3. A common electrode 7 is provided on the liquid crystal side of the other substrate 2. The liquid crystal forms a capacitance between the common electrode 7 and the pixel electrodes 3.

A source driver 10 is connected to the signal lines 4, and a gate driver 11 is connected to the scanning lines 5. A video signal, in the illustrated example a digital signal 12, is provided to a display controller 15, and both the source driver 10 and gate driver 11 are supplied with an output signal 13 and 14 respectively from the controller 15. A third output 16 from the controller 15 is provided to a common electrode driver 17, which in turn controls the common electrode 7.

In operation, the pixel electrodes are provided with a drive voltage from the source driver 10, and the common electrode is provided with a common voltage from the common electrode driver. Each pixel element is subject to a pixel voltage, equal to the potential difference between the drive voltage and the common voltage.

Turning now to FIG. 4, a block diagram shows how a method according to an embodiment of the invention is implemented in the controller 15. The process starts in step S1 with determining whether the display device is operated in active or standby mode.

In the first case (steps 2 and 3, performed in parallel), the source driver 10 and common electrode driver are provided with output signals 14 and 16 to generate a pixel voltage with alternating polarity, and the gate driver 11 is provided with an output signal 13 to generate a gate pulse train with a large amplitude, e.g. according to fig 1a or 1b mentioned above. When the display is operated in active mode, adjacent pixel lines can be driven by inversed polarities, so called line inversion drive. The pixel voltage with alternating polarity is then line inverted, according to known line inversion schemes, e.g. common electrode inversion. Line inversion has the advantage that any image retention built up during the standby mode will be masked by the alternating line polarities. Other examples of inversion schemes known in the art are frame inversion, column inversion and dot inversion.

In the second case (step 4 and 5, performed in parallel), the source driver 10 and common electrode driver are provided with output signals 14 and 16 to generate a pixel voltage with constant polarity, and the gate driver is provided with a gate pulse train with a lower amplitude, e.g. according to FIG. 2a mentioned above. The process returns regularly (step 6), for example after a predetermined number of frames, to step 1, so as to regularly determine the current mode of operation.

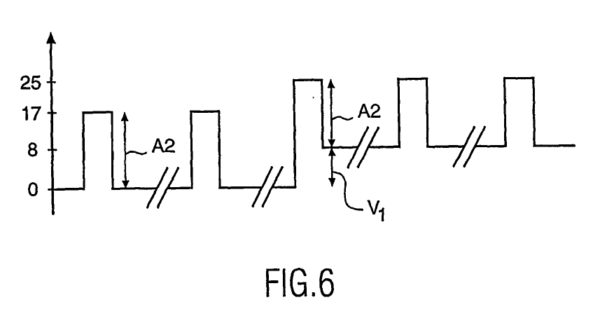

According to a second embodiment, the standby mode leg of the process is extended to switch the constant polarity of the pixel voltage at regular intervals. As illustrated in FIG. 5, this can be accomplished by including a binary variable X, which is switched (step 7) at certain time intervals (e.g. every minute, or every hour). In step 8, the polarity of the pixel voltage can then be set according to the variable X, before the constant polarity pixel voltage is generated in step 9. In this case, the gate voltage generated in step 10 must take into account the switching pixel voltage, and an example of a pulse train with these qualities is illustrated in FIG. 6.

To the left of FIG. 6, the pulses in the gate voltage pulse train have a constant amplitude (A2) equal to 17 V, enough for a pixel voltage of around −4 V. The moment the pixel voltage polarity switches to +4V, a gate pulse with an amplitude of 25 V is generated, to secure correct operation of the TFT. To the right of FIG. 6, i.e. after this larger pulse, the amplitude (A2) is again 17 V, but the whole pulse train has now been offset by a value v₁=8 V, so that the gate voltage now varies between 8 V and 25 V. This higher offset level v₁ is required by the 8 V higher pixel voltage (switched from −4 V to +4 V).

The method can preferably be implemented in an AMLCD of conventional type, by providing one or several of the controller 15, the gate driver 11, the source driver 10 and the common electrode driver 17 with new hardware and/or software components.

As mentioned above, the determination of operation mode of the display can be performed in a number of different ways, including manual selection by means of a selection switch, detection of manual activation, such as use of the apparatus equipped with the display device, detection of the video signal 12, in order to determine if its contents is changing rapidly, or detection of a power source 20 (e.g. a battery) power level. Any of these determination methods may be easily implemented by the skilled person in an apparatus equipped with a display device according to the invention. In FIG. 3 this is illustrated by a mode selector 18, arranged to provide a mode select signal 19 to the control unit 15. It should be noted that the mode selector 18 can be part of the display device, but also part of the apparatus that the display device is arranged in.

The concept of switching the display between a DC standby mode and an AC active mode could be extended to incorporate other methods to further reduce power consumption in the standby mode. Examples are reducing the number of gray levels, or reducing the frame frequency.

In summary, the present invention concerns s method for driving a liquid crystal display device according to which the liquid crystal pixel voltage has constant polarity when the display device is operated in standby mode, and alternating polarity when the display device is operated in active mode. As a result of this method it is possible to adjust the gate voltage pulse train to have a lower amplitude when the display device is operated in standby mode. The inventive drive method offers a way to combine the requirements of reduced image retention and lower power consumption.

1. A method for driving a liquid crystal display device having pixels comprising liquid crystal material arranged between electrodes, wherein a pixel voltage is provided between said electrodes the method comprising:
controlling the electrodes to provide a pixel voltage with constant polarity when the display device is operated in standby mode, and
controlling the electrodes to provide a pixel voltage with alternating polarity when the display device is operated in active mode.

2. A method according to claim 1, wherein the mode of operation is manually selected by a user.

3. A method according to claim 1, further comprising the step of detecting whether the display device is operated in standby or active mode.

4. A method according to claim 3, wherein said detecting step includes detecting a power level of a power source of said display device.

5. A method according to claim 3, wherein said detecting step includes analyzing a video signal supplied to said display device.

6. A method according to claim 1, further comprising:
providing a gate voltage to transistor elements in the display device, for activating or deactivating a particular pixel, said gate voltage shaving the form of a pulse train, and
adjusting said pulse train to have a first amplitude when the display device is operated in active mode, and a second amplitude when the display device is operated in standby mode.

7. A method according to claim 6, wherein said first amplitude is greater than said second amplitude.

8. A method according to claim 6, wherein said pulse train has a constant pulse amplitude when the display device is operated in standby mode.

9. A method according to claim 6, wherein the polarity of said pixel voltage with constant polarity is switched (&3 occasionally.

10. A method according to claim 9, wherein an offset of said pulse train is adjusted when the polarity of the pixel voltage changes.
